(19) United States
(12) Patent Application Publication
(10) Pub. No.: US 2010/0263492 A1
(43) Pub. Date: Oct. 21, 2010

(54) Bottle opening and closing device

(76) Inventors: Pat Y. Mah, Kowloon (HK); Alexander Joshef Kalogroulis, Coulsdon (GB); K.K. Tung, Kowloon (HK); Michael Ng, Medindie (AU)

Correspondence Address: Harrington & Harrington, P.O. Box 91719, LONG BEACH, CA, 90809-1719, US

(21) Appl. No.: 12/386,438

(22) Filed: Apr. 17, 2009

(51) Int. Cl. B67B 7/16

(52) U.S. Cl. 81/3.2

(57) ABSTRACT

A bottle opener and closer is battery powered and designed to drive a rubber-lined main drive cup which fits over a screw-on bottle cap. The main drive cup is has conically angled sides so that a small downward force on the opener and closer will cause the bottle cap to be positively engaged by a rubber liner to confer a high radial gripping force on the circumference of the bottle cap. The opener and closer may include a finger passage which allows insertion of a finger or other object for ejecting retained bottle caps. Accessory drive cups may be interfaced with the main drive cup to allow the opener to be used with an wide range of bottle cap sizes.

### FIELD OF THE INVENTION

The present invention relates to improved technology in the field of electric screw-top bottle openers and closers, and more particularly to a cordless, battery operated device which is hand-held, which is designed to securely grip a screw-on bottle cap, which has optional accessory cups to accommodate a wide variety of bottle cap sizes, and which can be driven in a first rotational direction to remove a bottle cap from a bottle or which can be driven in a second rotational direction to securely recap a bottle along with the use of a resistor during capping to insure that capping takes place with secure but less force than uncapping so that subsequent uncapping can take place even where battery power diminishes over time.

### BACKGROUND OF THE INVENTION

Various assistive devices are currently available for uncapping screw-top bottles, and a few also exist for the purpose of recapping screw-top bottles, though they may be notably fewer in number. One of the more simple conventionally available devices for unscrewing bottle caps is a rubber disc used to line the palm of the hand to improve the grip. Though these are relatively inexpensive and easy to acquire, a great deal of grasping strength is still required to grip and twist open a tightly closed cap.

Another conventionally available device for opening bottles is a plier-like apparatus, which usually includes some version of a partial metal ring lined with rubber or similar material which contacts the bottle cap when the device is employed. The diameter of the partial metal ring is adjustable, usually by squeezing together a pair of handles, one of which is attached at each terminus of the ring, or by simply opening a hinge. Generally, however, the range of ring diameter for these kinds of openers tends toward jar-sized lids rather than smaller, bottle-sized caps. Additionally, because the range of ring diameter achievable for each opener is fairly limited, multiple openers having different ring sizes would need to be stocked to anticipate the range of various lid sizes for which the device might be needed; where storage space is at a premium, this may not be feasible. Finally, these kind of openers not only requires enough hand strength to squeeze the handles of the device together so that sufficient circumferential pressure is exerted on the cap by the ring portion, but they also require maintaining that circumferential pressure while generating sufficient torque to unscrew the cap; this is definitely not a workable solution for those who have diminished upper extremity strength.

Other conventional openers include under-the-cabinet devices that may rely on a v-shaped receiving member which is typically serrated metal, into which a lid may be jammed so that the it is tightly gripped by the serrations as the user attempts to untwist the bottle or jar. These may include devices similar to Similar devices may include a track having walls spaced apart such that the distance between them becomes incrementally smaller as a bottle or jar lid is inserted and advanced. Once the lid is advanced to a point where the lid wedges between the walls of the track, the user may attempt to twist on the bottle or jar to open it. These types of openers are widely available and relatively inexpensive, but, like the rubber disc described above, they require sufficient arm strength to lift a jar or bottle, maneuver it into the v-shaped receiving member or track, and twist it until the lid loosens. Additionally, this kind of device is also typically geared toward larger jars rather than bottles.

Re-closing a screw-top bottle lid can also be especially difficult, if not impossible, proposition, either by hand or using any of the conventionally available devices described for gripping lids. Although the rubber disc most lends itself to tightly recapping a bottle, it does not lessen the amount of brute strength necessary to do so.

For users with weak upper extremities, such as the elderly or disabled, none of the conventionally available devices offer an adequate solution for opening or tightly closing screw-top bottles. Most available devices simply require far too much strength for those with diminished physical capacity to operate. Threaded beer bottle caps and soft drink caps are especially difficult to remove if strength is limited, but replacing screw-top threaded beer bottle caps and soft drink caps with any certainty that a leak can be avoided is nearly impossible for anyone without really good hand strength.

What is therefore needed is a device which can be used to open or tightly close a bottle cap, which is portable, which can accommodate a wide variety of bottle cap sizes, and which is power-driven to provide sufficient torque to remove or tightly replace a bottle cap independent of user strength.

### SUMMARY OF THE INVENTION

The bottle opener and closer of the present invention is affordable, effective, and superior to conventionally available alternatives. The present opener and closer is preferably cordless and may include a battery-powered motor designed to drive a rubber-lined main drive cup which fits over a consumer supplied screw-on bottle cap. The main drive cup may be conically angled or have a tapering conical angle in a variety of sizes to fit a wide variety of bottle-cap diameters, and may include an opening which allows insertion of a finger or other object for ejecting any bottle caps retained after the opening operation. The angle of the conically angled sides ensures that a small downward force on the opener and closer will cause the rubber liner to exert significant lateral grasping pressure onto the bottle cap to confer a high radial gripping force on the circumference of the bottle cap.

The present opener and closer may be ergonomically shaped to easily fit within a user's grip, and includes two side-mounted (right side and left side) momentary action switches which power the motor when activated and cut power to the motor when released once a cap has been successfully released or replaced. A master switch includes a first position to allow for driving the main drive cup in a first direction and a second position to allow for driving the main drive cup in a second direction rotationally opposite the first direction, and a third position which disenables movement in any direction.

In the case where a bottle cap may be larger or smaller than the range of bottle cap sizes accommodated by the main drive cup, accessory drive cups are available for interfacing with the main drive cup to allow the opener to accommodate a variety of other size ranges.

### BRIEF DESCRIPTION OF THE DRAWINGS

The invention, its configuration, construction, and operation will be best further described in the following detailed description, taken in conjunction with the accompanying drawings in which:

FIG. 1 is a an exploded view of the opener and closer of the present invention which illustrates an upper housing with finger passage, a lower housing, a gearbox, a motor, batteries, a gear drive, a main drive cup, a right-hand switch, a right-hand switch cap, a left-hand switch, a left-hand switch cap, and a directional center switch;

FIG. 2 is a perspective top view of the opener and closer of FIG. 1 as assembled, in which the upper housing with finger passage, lower housing right-hand switch cap, left-hand switch cap, and directional center switch are all visible;

FIG. 3 is a perspective bottom view of the of the opener and closer of the present invention in which the lower housing, left-hand switch cap, finger passage, and main drive cup are visible;

FIG. 4 is a cross-sectional view of the opener and closer along line 4-4 of FIG. 3 and illustrates upper housing with finger passage, lower housing, motor, directional center switch, gearbox, and main drive cup;

FIG. 5 is a cross-sectional view of a single accessory cup which includes an extension designed to be engaged by a main drive cup;

FIG. 6 is a cross-sectional view of a dual accessory cup which includes a lip at each end designed to interface with a main drive cup or a larger accessory cup;

FIG. 7 is a cross-sectional view of a dual accessory cup engaged by a larger single accessory cup;

FIG. 8 is a break-away view of the opener and closer of the present invention which illustrates a single accessory cup engaged by the main drive cup;

FIG. 9 is a break-away view of the opener and closer of the present invention which illustrates a dual accessory cup engaged by the main drive cup; and

FIG. 10 illustrates one possible realization of the circuit of the invention.

### DETAILED DESCRIPTION OF THE PREFERRED EMBODIMENT

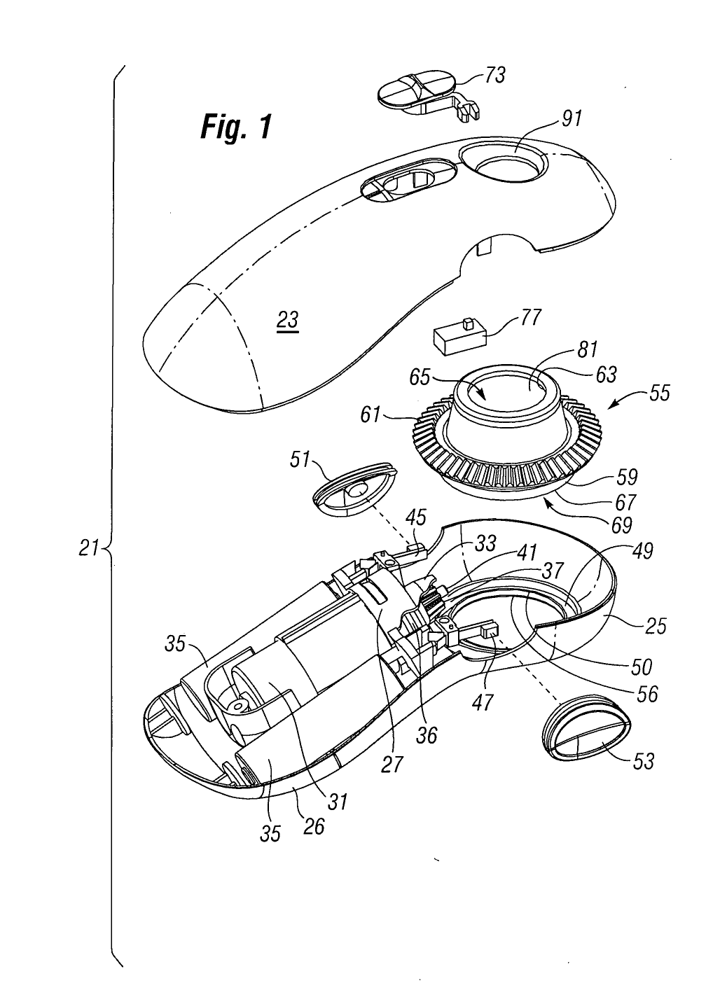

The description and operation of the invention will be best initiated with reference to FIG. 1, which is an exploded view of the opener and closer 21 of the present invention. Opener and closer 21 may include an upper housing 23, and a lower housing 25. Housings 23 and 25 are preferably constructed of rigid plastic but may conceivably be constructed of other materials such as stainless steel or aluminum. Upper housing 23 may be snap fitted to lower housing 25, or a separate battery door seen as a battery door portion 26 of lower housing. Alternately, housings 23 and 25 may be joined by any other suitable method which will allow opener and closer 21 to function properly.

Illustrated inside lower housing 25 is a gearbox 27, motor 31, pinion housing 33 and batteries 35. Gearbox 27 is illustrated as partially cut away to reveal a series of epicyclic gears 36. Pinion housing 33 is illustrated as being partially cut away to reveal bevel pinion 37 and shaft 41. Also illustrated in lower housing 25 is a left-hand power switch 45, and a right-hand power switch 47, either of which switches 45 and 47 may be leaf-type switches. A left-hand power button 51 is shown adjacent left-hand power switch 45 to accommodate right-handed users, and a right-hand power button 53 is shown adjacent right-hand power switch 47 to accommodate left-handed users. Activation of either of power buttons 51 or 53 powers motor 31. Also seen is an upwardly directed channel 49. Upwardly directed channel 49 may have an concentrically inner wall 50. The upwardly directed channel 49 will help to capture capture and stabilize a main drive cup 55 seen between the upper housing 23 and lower housing 25.

The main drive cup 55 is illustrated just above an opening 56 in lower housing 25. Main drive cup 55 includes an interior surface (to be described), an exterior surface 59, which includes a bevel gear 61, and an upper, circumferentially inwardly disposed, rim 63 extending between interior surface 57 and exterior surface 59 and surrounding a top opening 65. Main drive cup 55 includes a lower rim 67 adjacent exterior surface 59 and surrounding a lower opening 69 indicated by an upwardly pointing arrow and which will be more completely shown later. The liner 81 is seen also as an interior surface, the liner 81 being a thin lining of rubber or other polymeric with high skin friction.

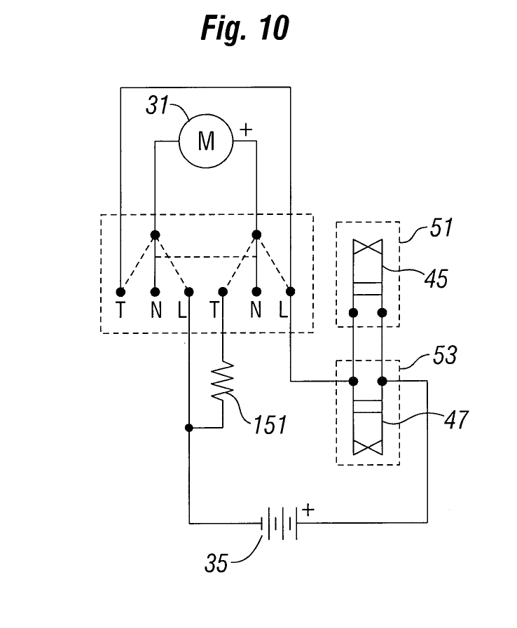

At the uppermost point of FIG. 1 a slide button 73 is illustrated and which has a mechanical extension which extends through an opening 75 in upper housing 23 to mechanically engage and control a slide switch 77 when opener and closer 21 is assembled. Slide switch 77 may be a 3-position double-pole switch which determines the direction of rotation of main drive cup 55 upon powering motor 31 by allowing a user to select a first position which causes main drive cup 55 to rotate counter-clockwise (for opening a bottle), a second position which causes main drive cup 55 to rotate clockwise (for closing a bottle), or a third, neutral or off position (this will be more completely illustrated in FIG. 10). The circuit which effects clockwise rotation of main drive cup 55 may incorporate a resistor or similar component (shown schematically in FIG. 10) so that power delivered to the motor when closing will be less than power delivered to the motor when opening. This arrangement minimizes the possibility of screwing on a bottle cap so tightly that opener and closer 21 may not be effective in removing it. Shaft 41 is fixed in bevel pinion 37 and turns on a bearing surface in pinion housing 33. Bevel pinion also turns in epicyclic gears 36.

Bevel pinion 37 may be fixed on shaft 41, which also supports epicyclic gears 36 and turns on a bearing surface in pinion housing 33. Motor 31 feeds epicyclic gears 36, which in turn rotate bevel pinion 37 clockwise (to drive bevel gear 61 counter-clockwise) or counter-clockwise (to drive bevel gear 61 clockwise) depending on what direction the user has pre-selected using slide button 73.

The inside of the main drive cup 55 has a liner 81 which may be overmolded to provide a tough surface which is resistive to degradation. Overmolding can as it also provides water seals at the top and bottom of the main cup 55 as it enables the surface of any overmolded parts of the main cup 55 to brought into close sealing contact with other surfaces of the opener and closer 21. In the alternative, a liner may be provided which is constructed of rubber or other conformable material having a high skin friction to facilitate gripping.

Main drive cup 55 is preferably frustoconical in shape, preferably having a conically angled wall angle of less than about 40 degrees from wall to opposite wall. Since the rubber liner 81 may be ideally thin and match the shape of any underlying surface, the liner 81 may preferably have the same angular relationship as a wall to wall angle of about twenty degrees. More specifically, a conical wall angle of about twenty degrees between the walls or about ten degrees flare from the normal axis seems to be a good compromise between grip and range of bottle cap sizes with which the main drive cup 55 may be used, since this angular wall orientation requires only a small amount of downward force to confer a high radial gripping force on the circumference of a bottle cap (not illustrated in FIG. 1). A conically angled relationship greater than about twenty degrees wall to opposite wall, might, depending upon the softness of materials chosen, require an excessive amount of downward force on opener and closer 21 to generate sufficient radial gripping force on a bottle cap to grip and remove or replace it. In the alternative, rubber liner 81 may be replaceable. Rubber liner 81 may also use friction, glue, self adhesive or other assisting component or shape to fit securely within main drive cup 55.

Additionally, top opening 65 of main drive cup 55 admits the upwardly projecting cylindrical portion 83, and circumferentially inwardly disposed rim 63 fits against a portion of the upwardly projecting cylindrical portion 83. The radial shoulder 85 fits just underneath the circumferentially inwardly disposed rim 63. Further, top opening 65, when the rubber liner 81 is in place, enables a finger or other object to be introduced into and through the rubber liner 81 from the top side. Further a finger passage 91 in upper housing 23 further facilitates entry into the top opening 65, even when opener and closer 21 is assembled. Once a bottle cap (not illustrated in FIG. 1) is inserted into lower opening 67 of main drive cup 55 and which is held by rubber liner 81 after it is removed from a bottle (not illustrated), a user may insert a finger into finger passage 91 (and through top opening 65 of main drive cup 55 and first open end 84 of liner 81) to eject the bottle cap (not illustrated) from the lower opening 69 of main drive cup 55.

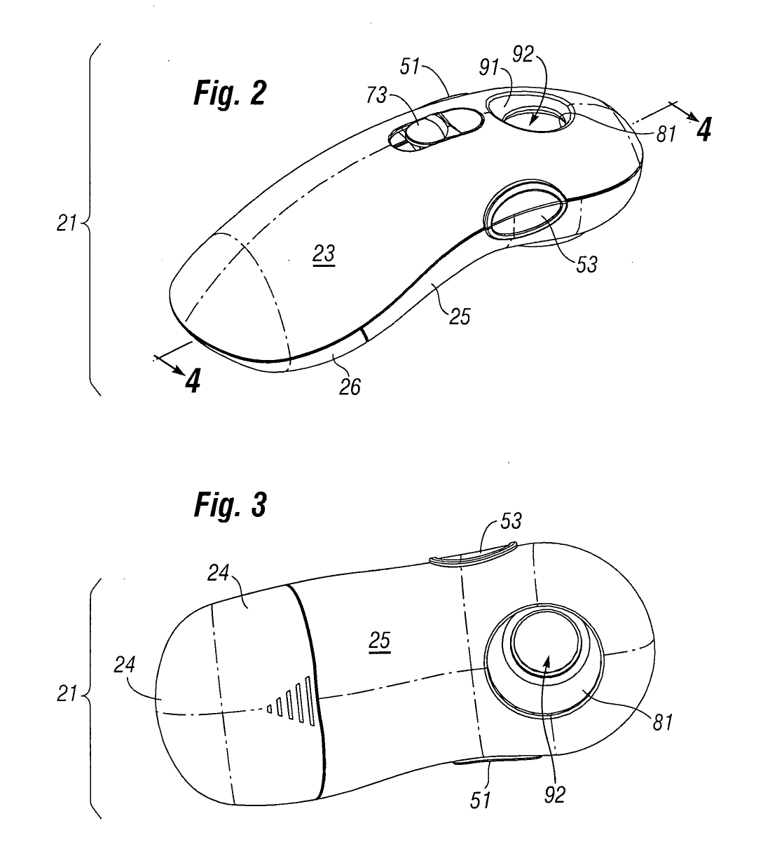

FIG. 2 is a perspective top view of the opener and closer 21 of FIG. 1 as assembled. FIG. 2 includes a view of upper housing 23, lower housing 25, right-hand power button 53, slide button 73, and finger passage 91. FIG. 2 also provides a partial view of left-hand power button 51 and liner 81 of main drive cup 55. FIG. 2 also provides a partial view of a through-hole 92 which remains accessible for the opener and closer 21 when its components are assembled.

FIG. 3 is a perspective bottom view of the underside of the opener and closer 21 of the present invention in which the lower housing 25, left-hand power button 51, right-hand power button 53, and through-hole 92 are all visible. Liner 81 of main drive cup 55 is also seen.

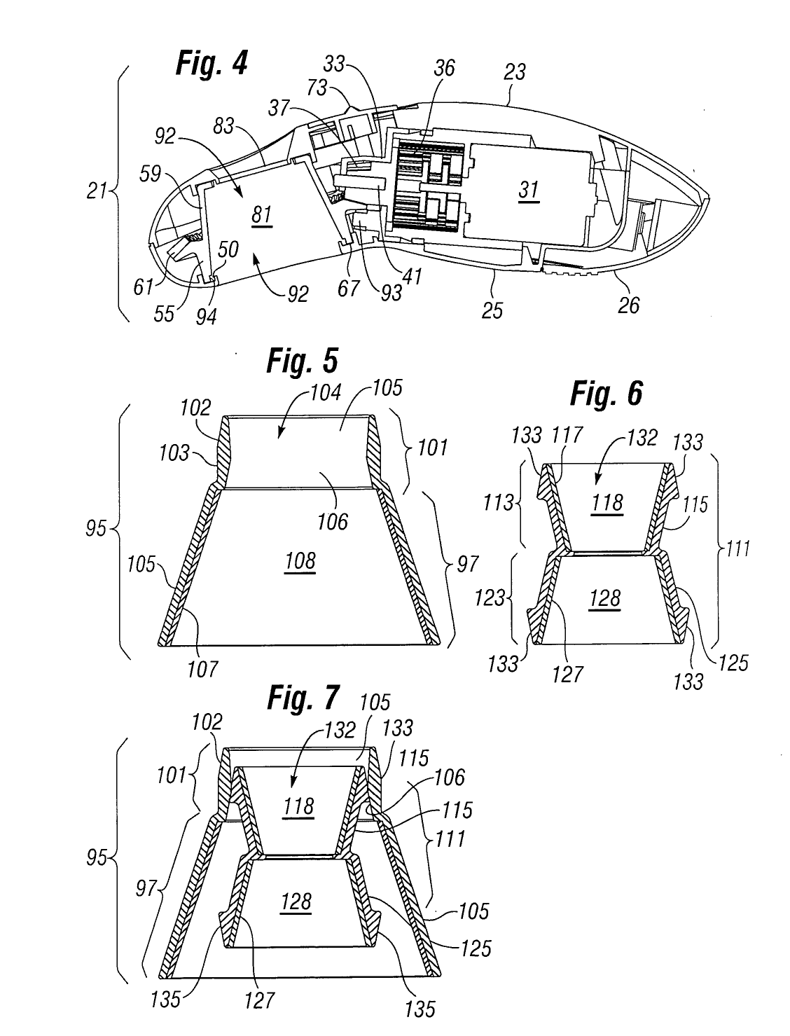

FIG. 4 is a cross-sectional view of the opener and closer 21 taken along line 4-4 of FIG. 2. Visible in FIG. 4 is the upper housing 23, lower housing 25, gearbox 27, motor 31, pinion housing 33, epicyclic gears 36, bevel pinion 37, shaft 41, bevel gear 61, main drive cup 55, including exterior surface 59, slide button 73, finger passage 91 in upper housing 23, and through-hole 92. Rubber liner 81 is omitted to better illustrate the relationship of the main drive cup 55 and surrounding structures. FIG. 4 also illustrates a roller 93 which traps bevel gear 61 between bevel pinion 37 and roller 93 to limit movement of bevel gear 61 away from bevel pinion 37 when by bevel pinion 37 is operating.

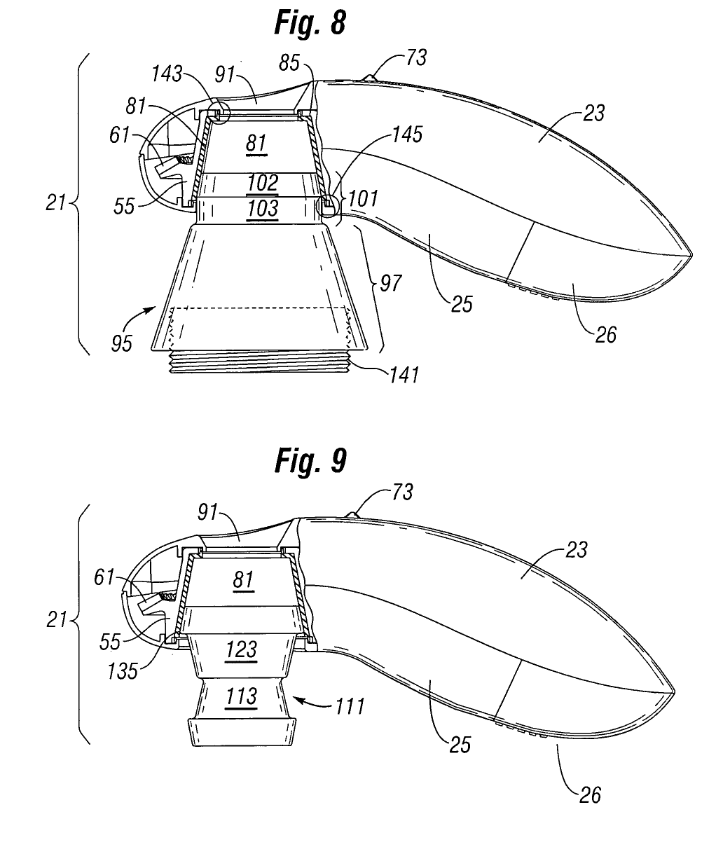

Also in FIG. 4, a groove 94 is visible adjacent interior surface 57 of drive cup 55 adjacent lower rim 67. When rubber liner 81 (not shown in FIG. 4 in order to see the small details) is present inside main drive cup 55, sealed structures may result (described in FIG. 8). Sealing may provide some protective barrier for any liquids which would otherwise enter the lower housing 25 over the concentrically inner wall 50 of the upwardly directed channel 49.

FIG. 5 is a cross-sectional view of a single accessory cup 95 which includes a main body 97 and an upper extension 101. An upper extension 101 may have specialized inner and outer surfaces. An angled upper exterior portion 102 forms a conic surface which is frictionally engagably compatible with the inner surface 89, engages with the overmolded liner 81 when supported by the interior surface 57 of the main drive cup 55. Below angled upper exterior portion 102 a cylindrical portion 103 is seen. A through-hole 104 extends through main body 97 and extension 101. Inside the extension 101, an upper cylindrical surface 105 lies above an angled surface 106. Angled surface 106 will be utilized in conjunction with other accessory cups to be shown.

The main body 97 may have a generally constant conic profile and may preferably have a rubber liner 107. Rubber liner 107 has an internal surface 108. The rubber liner 107 has a different shape than the rubber liner 81, and may be either permanently bonded to the main body 97, or the rubber liner 107 may be replaceable. Liner 107 is sized to conform to single accessory cup 95. When single accessory cup 95 is engaged by main drive cup 55, through-hole 104 preserves a user's ability to discharge a bottle cap from single accessory cup 95 by utilizing finger passage 91 just as described in FIG. 2.

Angled upper exterior portion 102 of upper extension 101 are sloped to match the conical angular wall relationship of main drive cup 55, ideally approximately twenty degrees from one side to the other or about ten degrees from axial to facilitate optimal gripping by main drive cup 55 at liner 81. If the bottle cap to be opened is larger or smaller than the range of cap sizes that can be opened using main drive cup 55, single accessory cup 95 may be used to further expand the range of possible bottle cap sizes for which opener and closer 21 may be used. Note that while the shape of the main body 97 of single accessory cup 95 is illustrated as having a higher conic angle than main drive cup 55 to accommodate larger sizes of bottle caps (bottle caps are not shown in FIG. 5), a lower conic angle than main drive cup 55 is also possible. Thus, any single accessory cup 95 can be provided to expand the range of possible bottle caps to include smaller or larger caps than those removable using only main drive cup 55. Moreover, the possible range of bottle cap sizes that may be accommodated using accessory cups is virtually limitless.

FIG. 6 is a cross-sectional view of a dual accessory cup 111 which includes a first cup 113 having conically angled exterior 115, a rubber liner 117, an interior surface 118 of the rubber liner 117 and an exterior surface 121. Dual accessory cup 111 also includes a second cup 123 having angled exterior surface 125, a liner 127, an interior surface 128 of liner 127 and an exterior surface 131. A through-hole 132 extends through the inside of the first cup 113 and the inside second cup 123. first cup 113 includes an exterior conic surface 133, and second cup 123 includes an exterior conic surface 135. Exterior conic surfaces 133 and 135 may be sloped to match the inner surface of the liner 81 of the main drive cup 55, which may be approximately twenty degrees from side to opposite side, to facilitate optimal gripping by main drive cup 55 at liner 81. Alternatively, the exterior conic surfaces 133 and 135 may be sloped to match surface 108, or angled surface 106, or other surfaces and combinations.

First cup 113 and second cup 123 may be two different sizes as shown to further expand the range of bottles openable using dual accessory cup 111. When dual accessory cup 111 is engaged by main drive cup 55, the through-hole 132 preserves a user's ability to discharge a bottle cap from single accessory cup 111 by utilizing finger passage 91 as described in FIG. 2.

FIG. 7 is a cross-sectional view of dual accessory cup 111 of FIG. 6 nested in single accessory cup 95 of FIG. 5 for efficient space-saving storage. Visible in FIG. 7 is single accessory cup 95 with the exterior conic surfaces 133 shown engaged with the angled surface 106 of single accessory cup 95. In the position shown, the surface 128 of liner 127 is set to engage a bottle cap (not shown). If the dual accessory cup 111 of FIG. 6 were reversed and re-nested in single accessory cup 95 of FIG. 5, with the exterior conic surfaces 135 shown engaged with the angled surface 106 of single accessory cup 95, the surface 118 of liner 117 is set to engage a bottle cap (not shown).

FIG. 8 is a partially broken-away view of the opener and closer 21 of the present invention which illustrates single accessory cup 95 engaged by main drive cup 55 at angled upper exterior sides 102 of extension 101. Also visible in FIG. 8 is upper housing 23, lower housing 25, liner 81 of main drive cup 55, slide button 73, finger passage 91 in upper housing 23, bevel gear 61, and main body 97 of and extension 101 of single accessory cup 95. A large bottle cap 141 is shown as having been engaged and held in place by the single accessory cup 95. It can be seen that with the liner 81 in place, that an upper seal 143 and a lower seal 145 is formed by the contact with other components when the main drive cup 55 is overmolded rather than simply having an attached liner.

FIG. 9 is breakaway view of the opener and closer 21 of the present invention which illustrates second cup 123 of dual accessory cup 111 engaged by main drive cup 55 at ridge 135. Also visible in FIG. 8 is upper housing 23, lower housing 25, finger passage 91 in upper housing 23, bevel gear 61, and first cup 113.

FIG. 10 illustrates one possible realization of the circuit of the invention. Motor 31 is shown schematically and is ideally a direct current motor. Batteries 35 are shown schematically as a battery symbol 35. The right hand power switch 47 is shown within a dashed line block labeled and representing right-hand power button 51 and the left hand power switch 45 is shown within a dashed line block labeled and representing left-hand power button 51. Right and left hand power switches 47 and 45 are shown as two switches capable of closing the same circuit. The slide switch 77 is shown as a three position double throw switch 77 as seen in FIG. 1 and now shown schematically. The position of the three position double throw switch 77 is currently shown in neutral position. If the three position double throw switch 77 is set to tighten a bottle cap 141, the switch is moved to the “T” position and the battery power is made available to the motor through the torque reducing resistor 151 when the circuit is to be completed by closing either of the right hand power switch 47 and the left hand power switch 45. If the three position double throw switch 77 is set to loosen a bottle cap 141, the switch is moved to the “L” position and the battery 35 power is made available to the motor without passing through the torque reducing resistor 151 when the circuit is be completed by closing either of the right hand power switch 47 and the left hand power switch 45.

Although the invention has been derived with reference to particular illustrative embodiments thereof, many changes and modifications of the invention may become apparent to those skilled in the art without departing from the spirit and scope of the invention. Therefore, included within the patent warranted hereon are all such changes and modifications as may reasonably and properly be included within the scope of this contribution to the art.

What is claimed:

1. An device for opening and closing bottle caps, comprising:
a housing;
a motor situated in said housing and having a shaft;
a power source situated in said housing;
at least one switch mounted on said housing and capable of connecting said motor to said power source; and
a main drive cup, said main drive cup attached to said housing and having a first end, an open second end, an interior surface, an exterior surface, and conically angled sides extending between said first end and said open second end; said shaft of said motor connected to said main drive cup for rotating said main drive cup.

2. The device recited in claim 1 wherein said housing comprises at least a first section and a second section and wherein said second section has a drive cup opening through which said open second end of said main drive cup can be accessed.

3. The device recited in claim 1 wherein said housing is curved along a length of said housing to attain an ergonomic shape.

4. The device recited in claim 2 wherein said first section of said housing is snap-fit to said second section of said housing.

5. The device recited in claim 4 wherein said first section of said housing includes a finger opening and said first end of main drive cup includes an opening, and wherein said opening in said main drive cup is situated adjacent said finger opening in said housing to enable at least one of a human finger and another object to be inserted through said finger opening and said opening of said first end of said main drive cup.

6. The device recited in claim 5 wherein said conically angled walls of said main drive cup are angled from between about 10 degrees and about 50 degrees.

7. The device recited in claim 6 and further including a liner within said main drive cup, said liner having a concentrically inwardly surface having a high coefficient of friction.

8. The device recited in claim 7 and wherein said liner is overmolded onto said main drive cup.

9. The device recited in claim 7 and further including a gear train between said shaft of said motor and said main drive cup.

10. The device recited in claim 9 wherein said gear train is an epicyclic gear train.

11. The device recited in claim 10 wherein said main drive cup is controllably rotatable in a first clockwise direction and a second, counter-clockwise direction.

12. The device recited in claim 11 and further comprising a directional switch for selecting the direction of rotation of said main drive cup.

13. The device recited in claim 12 and wherein said directional switch is a 3-position double pole switch.

14. The device recited in claim 12 and further comprising a pinion between said epicyclic gear train and said main drive cup, and wherein said exterior surface of said main drive cup includes a gear, said pinion engageable with said gear for rotating said main drive cup in a continuous motion about an axis of said main drive cup when said motor is activated.

15. The device recited in claim 13 and further including an accessory cup, attached to said main drive cup, said accessory cup having a different sized conically angled walls for expanding a range of sizes of caps which can be actuated by the device.

16. The device recited in claim 15 wherein said accessory cup includes a main body adjacent a first open end and an extension adjacent a second open end, said main body having conically angled sides, the angle of which differs from that of said conically angled sides of said main drive cup, and said extension having angled upper exterior sides to match the angle of said main drive cup.

17. The device recited in claim 15 wherein said accessory cup includes a first open end, a second open end, a through hole extending between said first and second open ends, conically angled sides, said conically angled sides differing in angle from that of said conically angled sides of said main drive cup, and a ridge adjacent at least one of said first and second open ends, said ridge angled to match the angle of said main drive cup.
